(19) United States
(12) Patent Application Publication
(10) Pub. No.: US 2016/0228211 A1
(43) Pub. Date: Aug. 11, 2016

(54) CROWN ASSISTANCE DEVICE

(71) Applicants: Tuan Anh Pham, Austin, TX (US); Andrew Sanderson, Austin, TX (US); Conley Wilson Giles, Austin, TX (US)

(72) Inventors: Tuan Anh Pham, Austin, TX (US); Andrew Sanderson, Austin, TX (US); Conley Wilson Giles, Austin, TX (US)

(21) Appl. No.: 14/938,825

(22) Filed: Nov. 11, 2015

Related U.S. Application Data
(60) Provisional application No. 62/079,720, filed on Nov. 14, 2014.

(51) Int. Cl. A61C 5/12; A61C 15/04; G05B 19/4099; A61C 5/10

(52) U.S. Cl. CPC A61C 5/12; A61C 5/10; A61C 15/041; G05B 19/4099; B33Y 50/00

(57) ABSTRACT

A crown assistive device includes a plurality of clips adapted to be fitted over teeth, each clip shaped with a curved exterior and an interior with an edge adapted to contact a crown, wherein the clips are spaced apart with openings to receive floss, and the ends of the clips on a first side are connected with a first bar and the ends of the clips on a second side are connected together as a second bar.

### BACKGROUND

The present invention relates to a crown assistance device.

The installation of permanent crowns to reconstruct a tooth, particularly human teeth, is a commonplace procedure generally accomplished in a sequence of steps over a prolonged period of time. Regarding the tooth shape replacement, it involves the preparation of a temporary crown and a permanent dental crown. The temporary crown is fitted onto a damaged tooth only for a limited period of time, typically from a few days to weeks. The permanent dental crowns then replace the temporary crown and serve as definitive tooth replacements and often remain in the patient's mouth for years or decades. For the dental crowns, it is also particularly important, in addition to the bite function, to ensure an attractive appearance of the tooth and of its surface. Ceramic has been used mainly as a suitable material for crowns intended as permanent crowns. It has good properties in respect of both functions. However, ceramic is an expensive material to machine.

Initially, impressions of the tooth to be reconstructed may be made to establish relationships with adjacent teeth. Then the tooth is ground to remove damaged portions and to provide a shape or “stump” which is adapted to receive the crown. Impressions or a mold is made from the shaped stump for transmittal to a dental laboratory where the permanent crown is molded. Prior to permanent fixation of the crown, a number of fittings are typically required.

In the meantime, while the crown is being prepared, it is necessary to keep the shaped tooth or stump protected from shock, further damage and exposure which could ultimately result in loss of the tooth. To accomplish this, a temporary crown or “crown form” is used to be installed on the shaped tooth immediately. Desirably, the crown form is quickly installed, well fitting, durable, easily removed and replaced and completely protective of the shaped tooth. Temporary crown forms or strip crowns are thin shells, commonly made of polycarbonate, typically used for holding and shaping a body of self curing plastic material. The thin shells become part of the temporary crown when filled with self-curing polymers. The gingival part of the shells is straight, rigid, and parallel and fits the gingival margins of the stump.

For restoration of anterior destroyed or broken tooth, instead of using a permanent crown, very thin, transparent and flexible shells exist that reproduce the final tooth size and shape. The shells are filled with semisolid composite material that flows during the insertion of the shell on the tooth and restore the broken part of the tooth. After placement the composite material is hardenned by applying a special blue light to the material. Thus, the necessity that the shell be transparent and very thin so it will not affect the penetration of the blue light to the composite material, and will not affect the final size of the restoration after its removal. The crown form is removed from the restoration after curing of the composite material intended to remain on the tooth and restore it. The tooth to be restored using the composite material goes through clinical processes well known to general dentists: first, the outer enamel surface have to be prepared using a strong acid (a procedure known by the name of etching); the strong acid dissolves the enamel and creates micro-retentions on the surface; into those micro-retention grooves the composite enters and remain attached to the tooth surface after curing.

Conventional crown forms come in several types. One type is a shell of thin metal such as aluminum or copper. The other type is a synthetic polymeric resin (polycarbonate) form. These forms are durable, but large inventories of shapes and sizes must be maintained since they are difficult to adapt to any given shape or size. Further, the commercially available polycarbonate crown forms generally fail to make mesial-distal tooth contact properly because they are not adjustable in this direction without extensive modification.

As for artificial teeth and crowns, according to the conventional approach they are made from metal, porcelain, combinations of metal and porcelain. Crowns made of precious or semi-precious metal are expensive and the luster inherent in the metal does not match well with the existing teeth and body tissue and is therefore not desirable. Porcelain crowns have been utilized and are typically produced from casts from the actual tooth location. However, the firing of porcelain causes dimensional changes therein, and hence, the finished tooth may not properly fit the patient. Because this type of artificial tooth requires high technology of porcelain building and firing and must have high dimensional accuracy, the production cost thereof is very high. Combinations of metal and porcelain in which the porcelain is built and baked on the crown surface to shade the luster of the metal crown have been found to be complicated and also expensive to produce. All of the hereinabove described artificial teeth and crowns require a laboratory necessary for the fabrication of the tooth and crown. As a result, the procedure becomes expensive due to repeated visits to the dental office for refitting and additional procedural steps for the dentist.

In connection therewith, and also as an independent source of artificial crowns and teeth, is the technology built around newly-developed resins and epoxies or the like which are quick-setting. In this procedure, the resin is disposed in a mold and inserted in a tooth. After a period of time, the mold with partially set resin is removed from the patient's mouth and shaped by the dentist. Subsequent to continued hardening of the resin, it is cemented in place in the patient's mouth by a composite restorative material, and thereafter finished by polishing. When the mold is cut away it leaves the composite restorative material to serve as a crown. Unfortunately, the form, when removed, leaves the cast tooth undersized. The following U.S. patents and publications present some examples of the current state of the art: U.S. Pat. Nos. 4,129,946; 5,487,663; 5,624,261; 5,709,548; 6,106,295. U.S. Application 20100297587 provides a dental crown formed of an elastically thermoplastic polymer material, said crown comprising: a tooth shaped top surface; and flexible side surfaces, at least one of which includes inwardly directed bottom portion.

When a dentist tests the fit of a crown onto a patient's tooth, it is often times difficult to test the fit of the crown interproximally—meaning that it is difficult to accurately hold the crown on the tooth in the mouth and use floss to test how tight or loose the floss feels when flossing the crown.

### SUMMARY

A crown assistive device includes a plurality of clips adapted to be fitted over teeth. Each clip is shaped with a curved exterior and an interior with two semicircular halves that are joined with a pointed edge that eventually contacts the crown. The clips are spaced apart with two openings to receive floss, and the ends of the clips are connected together by a bar. In one embodiment, three clips are used.

Advantages of the device may include one or more of the following. When installed on the teeth, the openings aid in testing the fit and contact of a crown. If a dentist has a contact too tight (floss is too difficult to floss and shreds), it will lead to potentially a crown that doesn't fit accurately all the way down onto the tooth. This leads to open margin. Open margin will lead to more rapid failure of the crown due to eventual decay (cavity) entering where the open margin is and occurring underneath the crown itself. This will lead to increased cost to the dentist (if they accept it was their fault and needs to replace it), cost to patient (if they patient has to pay for a new one) and potentially massive loss of tooth structure. If the contact is too loose, then food will get wedged between teeth often and is an annoyance to patient and will potentially cause more cavities b/c the food lingers there until it is removed via flossing later. This leads the patient complaining and potentially wanting it redone no charge if the crown is already cemented. This would mean the dentist incurs time loss and additional losses in cost associated with new crown. If the dentist happens to have machines or ovens that can add more material to the crown, this means there is also time loss and costs associated with the remake or adding material to the crown to close the gap.

With this device, the above occurrences will decrease and the predictability of a properly fitting crown will increase.

### BRIEF DESCRIPTION OF THE DRAWINGS

FIG. 1A shows a perspective view of a crown assistive device.

FIG. 1B shows a bottom view of the crown assistive device.

FIG. 1C shows a top view of the crown assistive device.

FIG. 1D shows a side view of the crown assistive device.

FIG. 2 shows an exemplary device mounted on the jaw.

FIG. 3 shows a floss with the exemplary device of FIG. 2.

FIG. 4 shows an exemplary process for generating the device of FIGS. 1A-1D.

FIGS. 5A-5D show another crown assistive device embodiment.

### DESCRIPTION

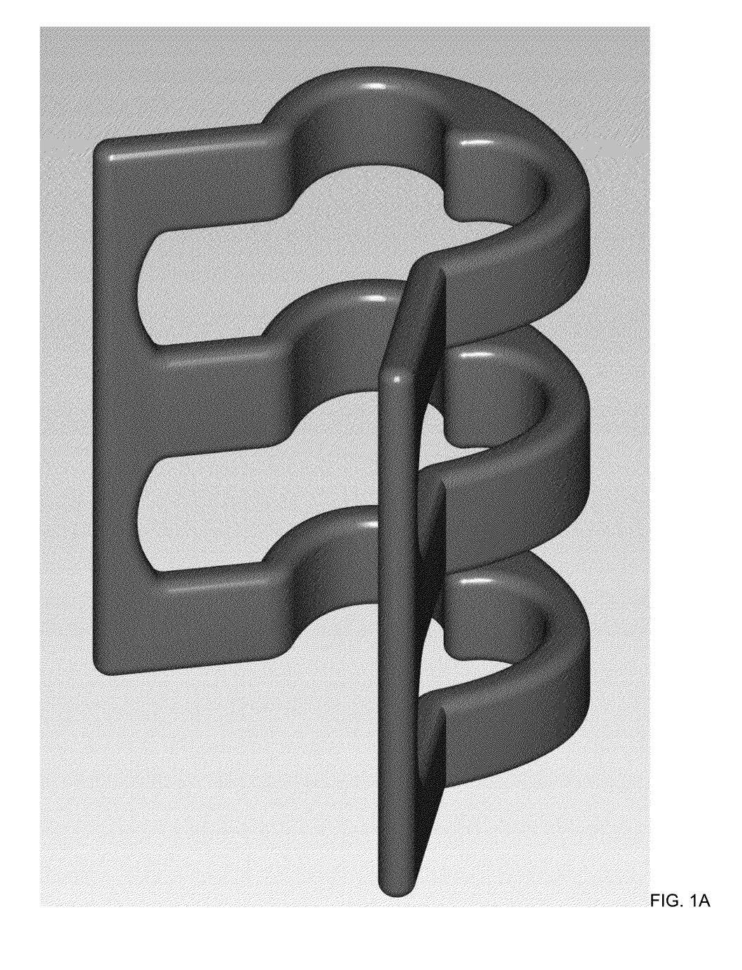

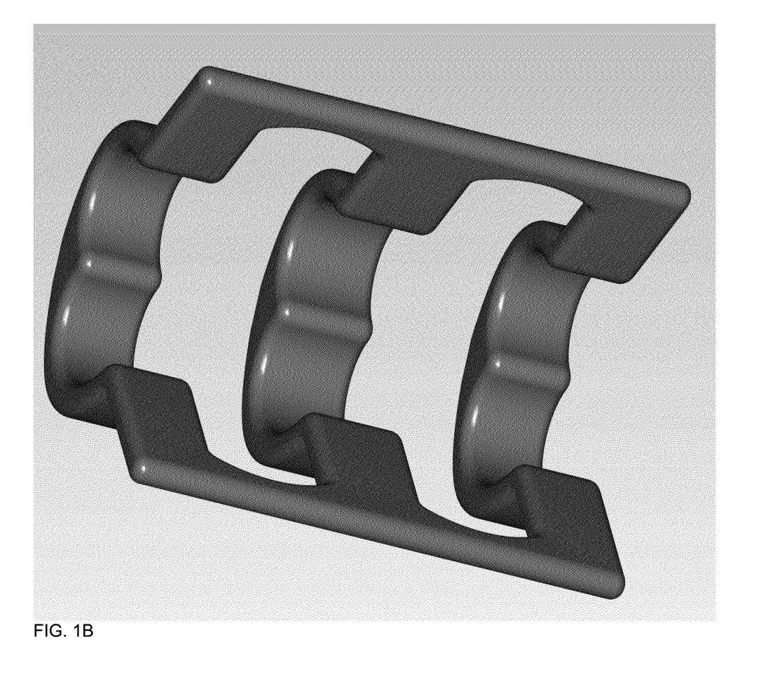

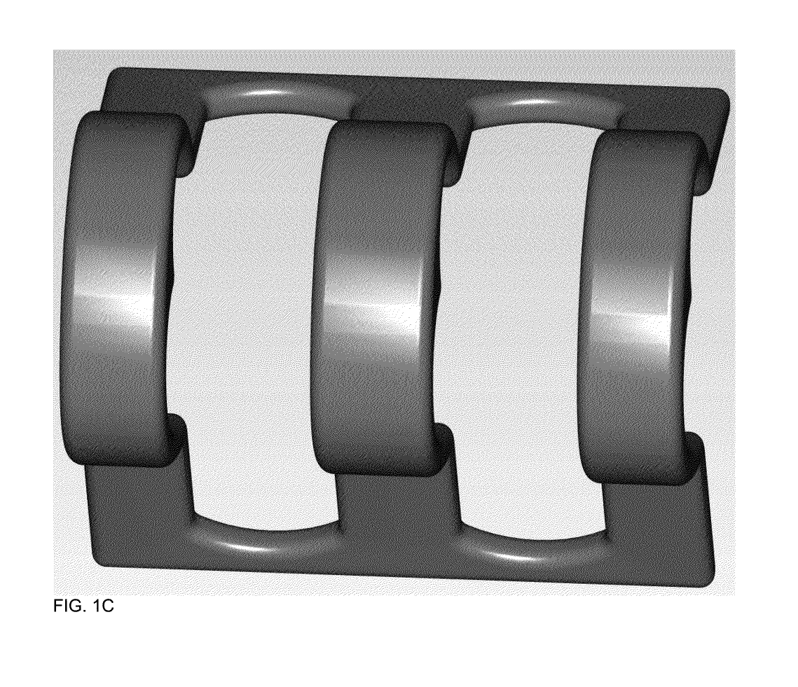

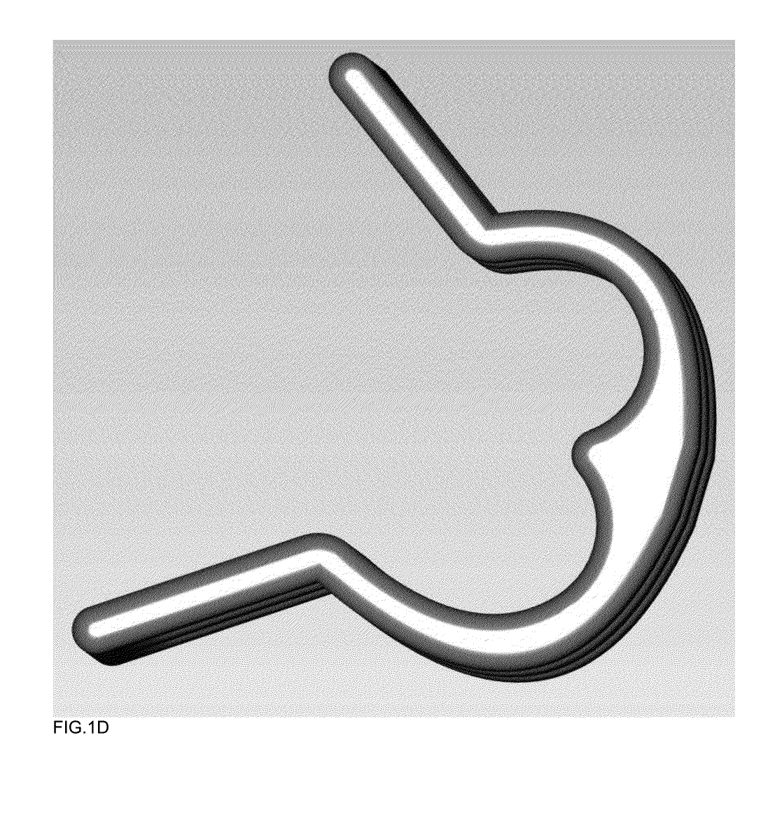

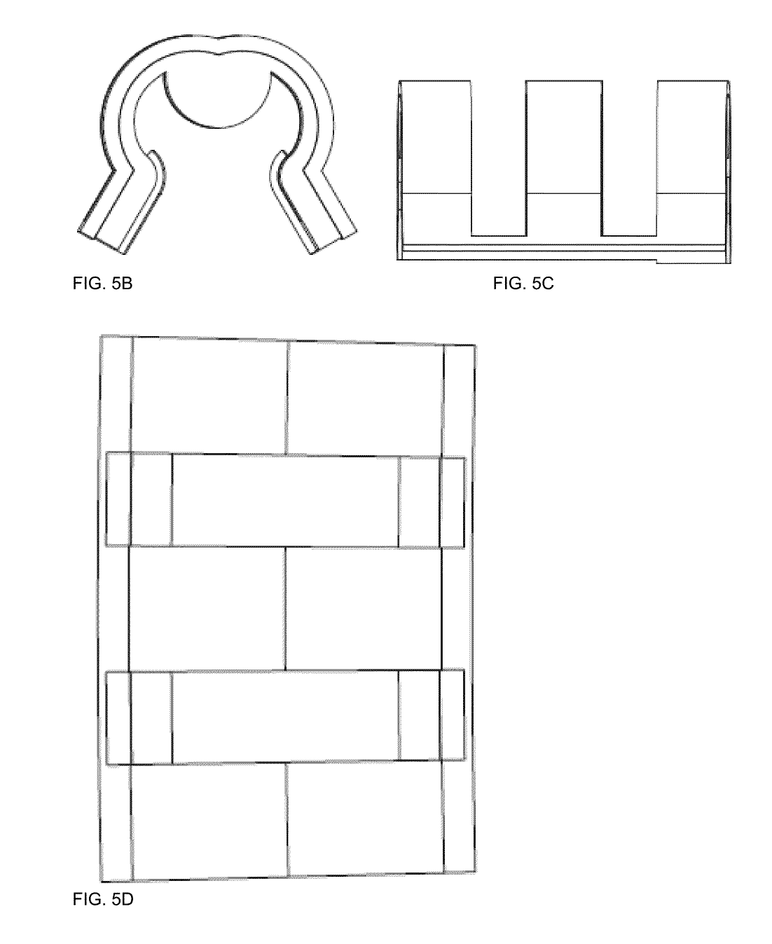

FIG. 1A shows an exemplary crown assistive device includes a plurality of clips adapted to be fitted over teeth. FIG. 1B shows a bottom view of the crown assistive device; FIG. 1C shows a top view of the crown assistive device; and FIG. 1D shows a side view of the crown assistive device. FIGS. 5A-5D show another crown assistive device embodiment.

Viewing FIGS. 1A-1D in combination, each clip is shaped with a curved exterior and an interior with two semicircular halves that are joined with a pointed edge that eventually contacts the crown. The clips are spaced apart with two openings to receive floss, and the ends of the clips are connected together by a bar. In one embodiment, three clips are used.

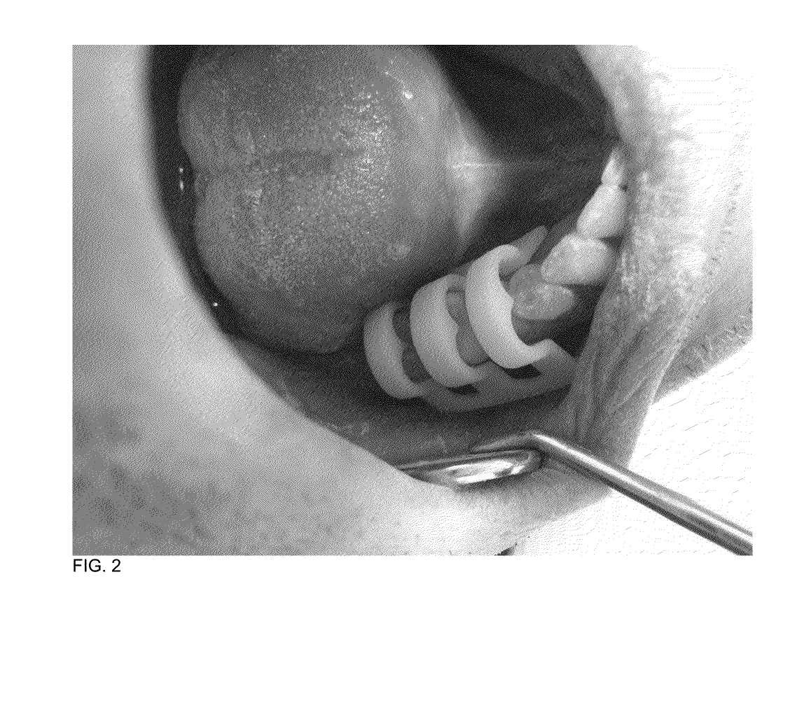

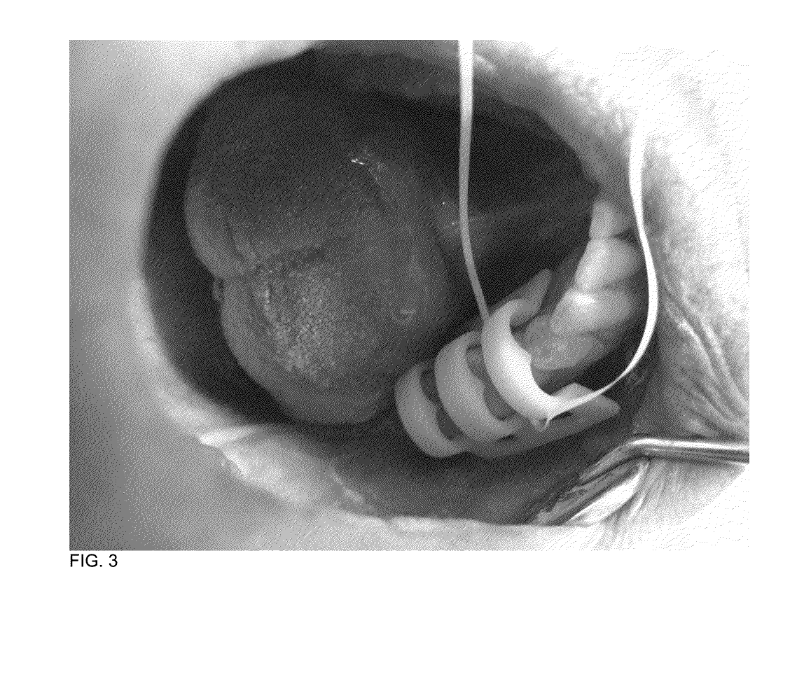

FIG. 2 shows an exemplary device mounted on the jaw, while FIG. 3 shows a floss with the exemplary device of FIG. 2. The Crown Assist device is designed to aid the dentist or the dental assistant in confirming accurate placement of a crown onto the tooth in the patient's mouth. The device allows the clinician to more accurately check the contact points of the crown with floss and decreases the risk of choking hazard to the patient and allows all this to be done with one person instead of typically two people.

The crown should not be too tight and shredding floss because patient compliance will decrease and they will not floss and more importantly, if it is too tight, it prevents full seating of the crown down, resulting in an open margin which is a space and gap formed at the edge of the crown and tooth. An open margin will lead to quicker failure of the crown and more tooth structure loss and cavities because food, saliva, bacteria will enter the gap. A properly fitting crown has no detected gap.

Conversely the crown should not be too loose to floss because if so, it will lead to a large gap which constantly traps food and is an annoyance and complaint to the patient. This can ultimately lead to patient wanting it redone which costs the dentist time and money.

When testing the fit of a crown, the dentist or the assistant will typically hold the crown awkwardly in one hand and try to somehow floss with the other. This is potentially dangerous if the patient swallows the crown, at the minimum the dentists have lost time and money due to new lab costs to make it or the patient will possibly choke on it and they will have to visit the ER for chest x-rays. o test it more accurately and less dangerously, another person can use an instrument or their finger to hold the crown onto the tooth while the other person flosses.

Crown assist will eliminate the risks and allow one person to easily check the contacts of the crown. The device allows accurate contacts and saves personnel time and reduces lab costs and fees by not over adjusting the tooth and causing a loose and large space when flossing.

Even with current CAD CAM technology and control over the pressure points of the contact space, many dentists will still want to check the contact manually in the mouth. There are factors, like machine variation, settings or imaging quality, that affects proper contact points and as such manual checking will still be in use.

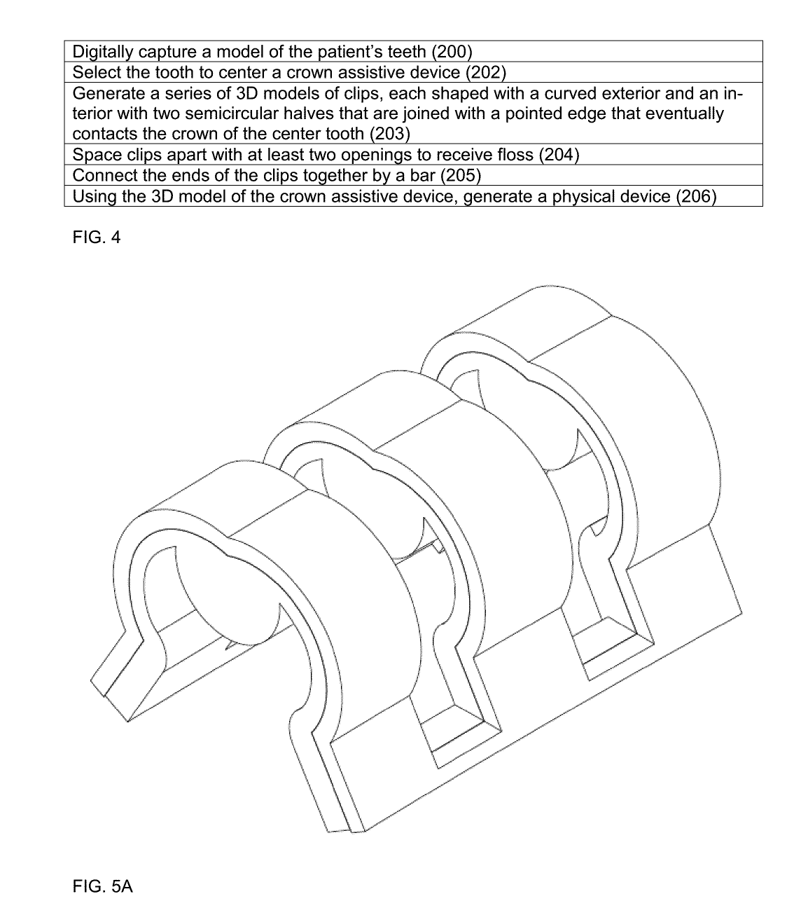

FIG. 4 shows an exemplary process for generating the device of FIGS. 1A-1 D. The process includes:

Digitally capture a model of the patient's teeth (200)

Select the tooth to center a crown assistive device (202)

Generate a series of 3D models of clips, each shaped with a curved exterior and an interior with two semicircular halves that are joined with a pointed edge that eventually contacts the crown of the center tooth (203)

Space clips apart with at least two openings to receive floss (204)

Connect the ends of the clips together by a bar (205)

Using the 3D model of the crown assistive device, generate a physical device (206)

In one embodiment, a three dimensional (3D) scanner can be used in 200 to capture a surface model of arbitrarily shaped objects such as dental structures. Scanners are devices for capturing and recording information from the surface of an object. The use of scanners to determine the surface contour of objects by non-contact optical methods has become increasingly important in many applications including the in vivo scanning of dental structures to create a 3D model. Typically, the 3D surface contour is formed from a cloud of points where the relative position of each point in the cloud represents an estimated position of the scanned object's surface at the given point.

A number of 3D scanners can be used. One such scanner is described in U.S. patent application which shows a scanner for optically imaging a dental structure within an oral cavity by moving one or more image apertures on an arm coupled to a fixed coordinate reference frame external to the oral cavity; determining the position of the one or more image apertures using the fixed external coordinate reference frame; capturing one or more images of the dental structure through one or more of the image apertures; and generating a 3D model of the dental structure based on the captured images.

One basic measurement principle behind collecting point position data for these optical methods is triangulation. In triangulation, given one or more triangles with the baseline of each triangle composed of two optical centers and the vertex of each triangle being a target object surface, the range from the target object surface to the optical centers can be determined based on the optical center separation and the angle from the optical centers to the target object surface. If one knows the coordinate position of the optical centers in a given coordinate reference frame, such as for example a Cartesian X,Y,Z reference frame, than the relative X, Y, Z coordinate position of the point on the target surface can be computed in the same reference frame.

Triangulation methods can be divided into passive triangulation and active triangulation. Passive triangulation (also known as stereo analysis) typically utilizes ambient light and the optical centers along the baseline of the triangle are cameras. In contrast, active triangulation typically uses a single camera as one optical center of the triangle along the baseline and, in place of a second camera at the other optical center, active triangulation uses a source of controlled illumination (also known as structured light).

Stereo analysis is based upon identifying surface features in one camera image frame that are also observed in one or more image frames taken at different camera view positions with respect to the target surface. The relative positions of the identified features within each image frame are dependent on the range of each of the surface features from the camera. By observing the surface from two or more camera positions the relative position of the surface features may be computed.

Stereo analysis while conceptually simple is not widely used because of the difficulty in obtaining correspondence between features observed in multiple camera images. The surface contour of objects with well-defined edges and corners, such as blocks, may be rather easy to measure using stereo analysis, but objects with smoothly varying surfaces, such as skin or tooth surfaces, with few easily identifiable points to key on, present a significant challenge for the stereo analysis approach.

To address this challenge, fixed fiducials or a formed pattern such as dots may be placed on a target object's surface in order to provide readily identifiable points for stereo analysis correspondence. WO 98/48242 entitled METHOD AND DEVICE FOR MEASURING THREE-DIMENSIONAL SHAPES by Hans Ahlen, et. al., the content of which is incorporated by reference, discloses a method for measuring the shape of an object by first applying a pattern of paint to the object's surface and then observing the object from a multitude of positions. The pattern of paint is used in conjunction with the multiple images to perform a stereo analysis to calculate the shape of the target object's surface.

Active triangulation, or structured light methods, overcomes the stereo correspondence issue by projecting known patterns of light onto an object to measure its shape. The simplest structured light pattern is simply a spot of light, typically produced by a laser. The geometry of the setup between the light projector and the position of the camera observing the spot of light reflected from the target object's surface enables the calculation of the relative range of the point on which the light spot falls by trigonometry. Other light projection patterns such as a stripe or two-dimensional patterns such as a grid of light dots can be used to decrease the required time to capture the images of the target surface.

The measurement resolution of the target objects' surface features using structured lighting methods is a direct function of the fineness of the light pattern used and the resolution of the camera used to observe the reflected light. The overall accuracy of a 3D laser triangulation scanning system is based primarily upon its ability to meet two objectives: 1) accurately measure the center of the illumination light reflected from the target surface and 2) accurately measure the position of the illumination source and the camera at each of the positions used by the scanner to acquire an image.

To achieve the second objective, commercial 3D scanners typically utilize precision linear or rotational stages to accurately reposition either the illuminator/camera pair or the target object between image acquisitions. However, a variety of real-world situations such as 3D imaging of intra oral human teeth do not lend themselves to the use of conventional linear or rotational stages. Further, the great range in sizes and shapes of the human jaw and dentition make the use of a single fixed path system impractical.

Commercially available 3D scanner systems have been developed for the dental market that accommodate the variety of human dentition by incorporating an operator held, wand type scanner. In these systems, the operator moves the scanner over the area to be scanned and collects a series of image frames. In this case however, there is no known positional correspondence between image frames because each frame is taken from an unknown coordinate position that is dependent upon the position and orientation of the wand at the instance the frame was taken. These handheld systems must therefore rely on scene registration or the application of an accurate set of fiduicals over the area to be scanned. For example, U.S. Pat. No. 6,648,640 entitled INTERACTIVE ORTHODONTIC CARE SYSTEM BASED ON INTRA-ORAL SCANNING OF TEETH by Rudger Rubbert et. al., the content of which is incorporated by reference, discloses a scanner which acquires images of the denture which are converted to three-dimensional frames of data. Pattern recognition can then be used to register the data from several frames to each other to provide a three-dimensional model of the teeth.

For 3D structures such as teeth, the use of pattern recognition or fidicials for frame registration is not optimal since tooth surfaces do not always provide sufficient registration features to allow high accuracy scene registration and accurate placement of fiducials to the required resolution is impractical over anything but the smallest tooth. Other 3D scanners can be used. For example, U.S. Pat. No. 4,837,732 entitled METHOD AND APPARATUS FOR THE THREE-DIMENSIONAL REGISTRATION AND DISPLAY OF PREPARED TEETH and U.S. Pat. No. 4,575,805 entitled METHOD AND APPARATUS FOR THE FABRICATION OF CUSTOM-SHAPED IMPLANTS, both by Brandestini and Moermann, and whose contents are incorporated by reference, disclose a scanning system for in vivo, non-contact scanning of teeth and a method for optically mapping a prepared tooth with a non-contact scan-head. The non-contact scanner includes a light emitting diode which is used in conjunction with a plurality of slits to form a structured light pattern on a tooth's surface. The reflected light is recorded by a linear charge coupled device sensor array. Triangulation is used to map the surface contour of the scanned teeth.

U.S. Pat. No. 5,372,502 entitled OPTICAL PROBE AND METHOD FOR THE THREE-DIMENSIONAL SURVEYING OF TEETH by Massen et al., the content of which is incorporated by reference, discloses an optical based scanner for measuring the surface contour of teeth that has a similar principle of operation. As noted in the Massen et al. patent, the Biandestini et al. technique is difficult to use when there are large variations in surface topography since such large variations in the surface displace the pattern by an amount larger than the phase constant of the pattern, making it difficult to reconstruct the pattern of lines. Furthermore, precise knowledge of the angle of incidence and angle of reflection, and the separation distance between the light source and the detector, are needed to make accurate determinations of depth. Furthermore, the scanner has to be rather carefully positioned with respect to the tooth and would be unable to make a complete model of a jaw's dental structure.

U.S. Pat. No. 5,027,281 entitled METHOD AND APPARATUS FOR SCANNING AND RECORDING OF COORDINATES DESCRIBING THREE DIMENSIONAL OBJECTS OF COMPLEX AND UNIQUE GEOMETRY by Rekow et. al., the content of which is incorporated by reference, discloses a scanning method using a three axis positioning head with a laser source and detector, a rotational stage and a computer controller. The computer controller positions both the rotational stage and the positioning head. An object is placed on the rotational stage and the laser beam reflects from it. The reflected laser beam is used to measure the distance between the object and the laser source. X and Y coordinates are obtained by movement of the rotational stage or the positioning head. A three-dimensional virtual model of the object is created from the laser scanning. Thus, a plaster model of teeth can be placed on a rotational stage for purposes of acquiring shape of the teeth to form a pattern for a dental prosthesis.

U.S. Pat. No. 5,431,562 entitled METHOD AND APPARATUS FOR DESIGNING AND FORMING A CUSTOM ORTHODONTIC APPLIANCE AND FOR THE STRAIGHTENING OF TEETH THEREWITH by Andreiko et al., the content of which is incorporated by reference, describes a method of acquiring certain shape information of teeth from a plaster model of the teeth. The plaster model is placed on a table and a picture is taken of the model's teeth using a video camera positioned a known distance away from the model, looking directly down on the model. The image is displayed on an input computer and a positioning grid is placed over the image of the model teeth. The operator manually inputs X and Y coordinate information of selected points on the model teeth, such as the mesial and distal contact points of the teeth. An alternative embodiment is described in which a laser directs a laser beam onto a model of the teeth and the reflected beam is detected by a sensor. Neither technique achieves in vivo scanning of teeth.

Systems and methods have been developed that allow in vivo scanning of teeth while avoiding the need to perform pattern recognition or use fiducials for image frame registration. In these systems the accurate surface contour of a scanned object is computed from a series of active triangulation image capture frames where each frame is obtained from precisely known positions of the image aperture. U.S. Pat. No. 6,592,371 entitled METHOD AND SYSTEM FOR IMAGING AND MODELING A THREE DIMENSIONAL STRUCTURE by Durbin, et. al., the content of which is incorporated by reference, discloses a method for optically imaging the dental structure using one or more image apertures movably coupled to an intra-oral track in a manner that results in each captured image frame being obtained from a known position with respect to all other captured images. By gathering each image frame through an image aperture that is at a known position and orientation as the aperture traverses along an intra oral track this method allows the 3D surface contour of the teeth and jaw dentia to be directly computed without performing frame registration.

The intra oral cavity represents a significant challenge for accurate in vivo 3D imaging of the surface of teeth and tissue. The ability to accurately measure the center of a scanning line is affected by the translucency of teeth, the variety of other reflecting surfaces (amalgam fillings, metal crowns, gum tissue, etc.) and the obscuration due to adjacent surfaces. Further, linear or rotational motion adds to error accumulation and the variation in size and curvature of human jaws makes a “one size fits all” scanner problematic.

If software application of this were created in combination with a 3D printer, custom Crown Assists could be made which would provide very intimate holding of the crown against the tooth to check contacts and aid in easier seating of the crown and clean up of cement or resin. Custom software creation and printing of Crown Assist will assure the most accurate fit of the device and allow Crown Assist to work in situations out of the norm (e.g. extremely mal positioned teeth out of alignment in buccal-lingual direction or occlusal-gingival direction).

With the rise in CAD CAM technology and 3D printing, it is likely that in the future, most dentists will have a 3D printer. Many 3D printers are open source and accept a standard CAD CAM file. It would be feasible for the dentist of the future to somehow export the data (dimensions and/or images of the scanned arch) that the CAD CAM machine creating the teeth into the 3D printer. With that data supplied, it will be possible for the dentist to either create a custom Crown Assist from his/her 3D printer. Either a software could be created to create a custom Crown Assist or a stock Crown Assist file could be modified to custom fit one using the information and data supplied. A custom fit one could be used more accurately to aid in seating and bonding/cementation of the crown in addition to checking contacts. (Current crown assist could also be used for that method also).

In addition, the model produced by the system described above can be automatically fused and displayed with other 3D images such as CT, MR or any other imaging that provides a 3D data set. Thus, if the patient's anatomy is known relative to a fixed reference, the model generated by the scanner system can be displayed so that it automatically correlates with an imaging data base for display purposes.

It is to be understood that various terms employed in the description herein are interchangeable. Accordingly, the above description of the invention is illustrative and not limiting. Further modifications will be apparent to one of ordinary skill in the art in light of this disclosure.

The invention has been described in terms of specific examples which are illustrative only and are not to be construed as limiting. For example, although the buffer memory is described as high speed static random access memory (SRAM), the memory can be any suitable memory, including DRAM, EEPROMs, flash, and ferro-electric elements, for example. The invention may be implemented in digital electronic circuitry or in computer hardware, firmware, software, or in combinations of them.

Apparatus of the invention may be implemented in a computer program product tangibly embodied in a machine-readable storage device for execution by a computer processor; and method steps of the invention may be performed by a computer processor executing a program to perform functions of the invention by operating on input data and generating output. Suitable processors include, by way of example, both general and special purpose microprocessors. Storage devices suitable for tangibly embodying computer program instructions include all forms of non-volatile memory including, but not limited to: semiconductor memory devices such as EPROM, EEPROM, and flash devices; magnetic disks (fixed, floppy, and removable); other magnetic media such as tape; optical media such as CD-ROM disks; and magneto-optic devices. Any of the foregoing may be supplemented by, or incorporated in, specially-designed application-specific integrated circuits (ASICs) or suitably programmed field programmable gate arrays (FPGAs).

While the above embodiments have involved application of luminescent substances to dental structures, the invention is applicable to all non-opaque surfaces. Although an illustrative embodiment of the present invention, and various modifications thereof, have been described in detail herein with reference to the accompanying drawings, it is to be understood that the invention is not limited to this precise embodiment and the described modifications, and that various changes and further modifications may be effected therein by one skilled in the art without departing from the scope or spirit of the invention as defined in the appended claims.

What is claimed is:

1. A crown assistive device, comprising:
a plurality of clips adapted to be fitted over teeth, each clip shaped with a curved exterior and an interior with an edge adapted to contact a crown, wherein the clips are spaced apart with openings to receive floss, and the ends of the clips on a first side are connected with a first bar and the ends of the clips on a second side are connected together as a second bar.

2. The device of claim 1, wherein the edge is pointed toward a tooth.

3. The device of claim 1, wherein the clip comprises two semi-circular halves joined at one end.

4. The device of claim 1, wherein the clips and the bar form a spring.

5. The device of claim 1, wherein the clips are spaced apart with two openings to receive floss.

6. The device of claim 1, comprising three clips linked coupled together with two bars.

7. The device of claim 1, wherein the bars are angled.

8. The device of claim 1, wherein the bars are angled.

9. The device of claim 1, wherein the clips and the bars are 3D-printed.

10. The device of claim 1, wherein the clips and the bars are customized to each patient's dentition.

11. A method for fabricating a dental appliance, comprising:
digitally capturing a model of the patient's teeth;
selecting a tooth to center a crown assistive device;
generating a series of 3D models of clips, each shaped with a curved exterior and an interior with two semicircular halves that are joined with a pointed edge adapted to contacts the crown of the center tooth.

12. The method of claim 11, comprising spacing clips with at least two openings to receive floss.

13. The method of claim 11, comprising connecting the ends of the clips together by a bar on each side.

14. The method of claim 11, comprising generating a 3D model of the crown assistive device.

15. The method of claim 14, comprising generating a physical device from the 3D model.

16. The method of claim 11, wherein the bars are angled.

17. The method of claim 11, wherein the bars are angled.

18. The method of claim 11, wherein the clips and the bars are 3D-printed.

19. The method of claim 11, wherein the clips and the bars are customized to each patient's dentition.

20. A system to fabricate a crown assistive device, comprising:
a 3D scanner to scan patient dentition;
a computer aided design (CAD) system coupled to the 3D scanner to generate the crown assistive device;
a fabrication machine coupled to the CAD system to fabricate a plurality of clips adapted to be fitted over teeth, each clip shaped with a curved exterior and an interior with an edge adapted to contact a crown, wherein the clips are spaced apart with openings to receive floss, and the ends of the clips on a first side are connected with a first bar and the ends of the clips on a second side are connected together as a second bar.
